(19) United States
(12) Patent Application Publication
(10) Pub. No.: US 2015/0340067 A1
(43) Pub. Date: Nov. 26, 2015

(54) System and Method to Generate a Video on the Fly

(71) Applicant: IDOMOO LTD., Hod Hasharon (IL)

(72) Inventors: Danny KALISH, Raanana (IL); Assaf FOGEL, Kfar-Saba (IL); Idan SHENBERG, Aseret (IL)

(73) Assignee: IDOMOO LTD., Hod Hasharon (IL)

(21) Appl. No.: 14/284,821

(22) Filed: May 22, 2014

(51) Int. Cl. G11B 27/031; G11B 20/00; H04N 9/802; H04L 29/06

(52) U.S. Cl. CPC G11B 27/031; H04L 65/60; H04L 65/4069; G11B 20/00007; H04N 9/802; G11B 2020/00072

(57) ABSTRACT

The present invention provides a method for real-time generation and streaming of context based video according to video template and raw context related data. The method comprising the steps of: receiving context based video request that is containing a template identifier and required template input, receiving input data related to the identified template and context related data; choosing and generating audible and visual materials, according to the predefined logic of the identified template, generating and encoding video frames for pre-defined portion based generated visual materials, generating audio streams of the video based on generated audible materials, accumulating a predefined number of generated frames to fill a predefined duration of predefined portion according to per-decided frame-rate per second and providing streamable data of the predefined video portion at the external entity side, while the subsequent portion of video is still in generation.

### BACKGROUND

1. Technical Field

The present invention relates generally to generation of context based video files based on predefined templates. More particularly, the present invention relates to on the fly generation of context based video.

2. Discussion of Related Art

In the known in the art video streaming, the video is generated in advance and only streamed in real time. When customized videos are generated for large number of users or clients and video generation is based on personal data of the users, it is required first to generate and record separate video for each user, before it can be streamed to the client.

The present invention provides system and method for real time generation of customized video while the video is streamed

### BRIEF SUMMARY

The present invention provides a method for real-time generation and streaming of context based video according to video template and raw context related data. The method comprising the steps of: receiving context based video request that is containing a template identifier and required template input, receiving input data related to the identified template and context related data; choosing and generating audible and visual materials, according to the predefined logic of the identified template, generating and encoding video frames for pre-defined portion based generated visual materials, generating audio streams of the video based on generated audible materials, accumulating a predefined number of generated frames to fill a predefined duration of predefined portion according to per-decided frame-rate per second and providing streamable or playable data of the predefined video portion at the external entity side, while the subsequent portion of video is still in generation.

According to some embodiments of the present invention the context based video is customized video based on context input data.

According to some embodiments of the present invention the received input data is validated and translated into a valid canonical entity for generating material for the context based video.

According to some embodiments of the present invention the audio stream generation includes: refining and concatenating audio streams in proper gaps and order according to rules defined during the Visual and Audible materials preparation

According to some embodiments of the present invention the audio stream generation further includes: processing and mixing together audio streams to create a single audio stream to be used as the final audio stream for the video.

According to some embodiments of the present invention the expected movie length is deduced based audio stream length.

According to some embodiments of the present invention the providing playable video data includes creating at least two HLS segments and generating an HLS manifest file.

The present invention provides a system for real-time generation and streaming of context based video according to video template and context input data . The system comprised of: interception module for receiving context based video request that is containing a template identifier and required template input, receiving input data related to the identified template and to specific context based on context input data, visual and audio material preparation module choosing and generating audible and visual materials, according to the predefined logic of the identified template, video generating management module for generating and encoding video frames for pre-defined portion based generated visual materials, audio generation module for generating audio streams of the video based on generated audible materials and video encoding module for accumulating a predefined number of generated frames to fill a predefined duration of predefined portion according to per-decided frame-rate per second and video distribution module for providing streamable or playable data of the predefined video portion at the client side, while the subsequent portion of video is still in generation process.

According to some embodiments of the present invention the context based video is customized video based on context input data.

According to some embodiments of the present invention the received input data is translated into a valid canonical entity for generating material for the context based video.

According to some embodiments of the present invention the audio stream generation module further enable refining and concatenating audio in proper gaps and ordering according to rules defined during the Visual and Audible materials preparation module

According to some embodiments of the present invention the audio stream generation module further enable and processing and mixing together audio streams to create a single audio stream to be used as the final audio stream for the video.

According to some embodiments of the present invention real-time generation and streaming of customized or personalized video based on video template and raw personal data. The method comprising the steps of: estimating video characteristics base on video template and raw data before the video generation, said estimating includes at least the video length and preparing at least a portion of the video, according to pre-defined length of at least the minimum required amount to convey a live stream to the remote entity while the subsequent portions of the video are being generated.

These, additional, and/or other aspects and/or advantages of the present invention are: set forth in the detailed description which follows; possibly inferable from the detailed description; and/or learnable by practice of the present invention.

### BRIEF DESCRIPTION OF THE SCHEMATICS

The present invention will be more readily understood from the detailed description of embodiments thereof made in conjunction with the accompanying drawings of which:

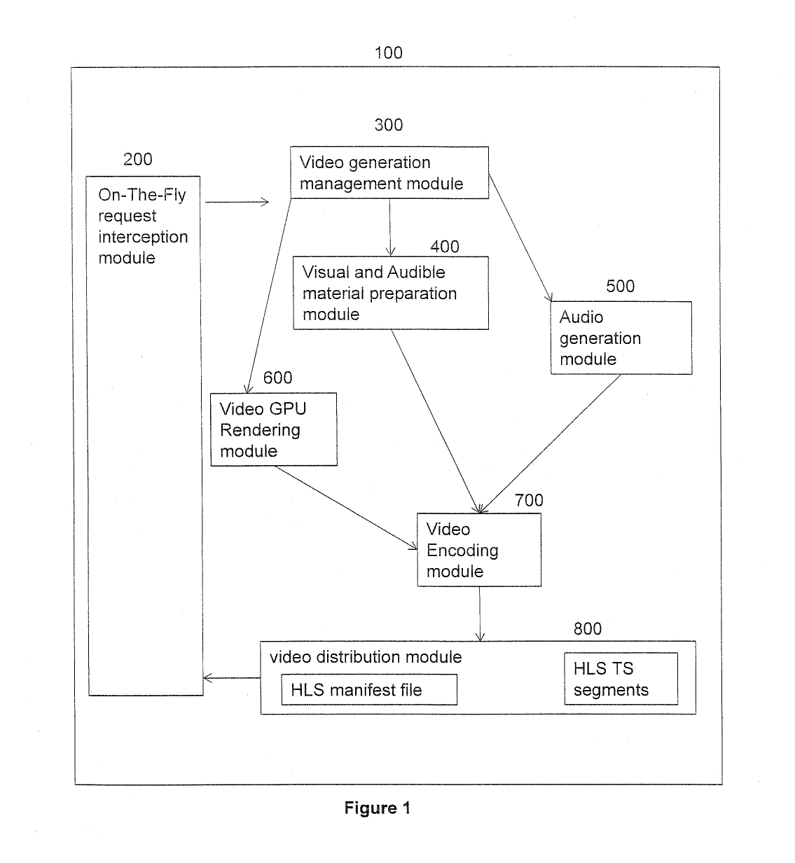

FIG. 1 is a block diagram of real-time video generation process, according to some embodiments of the invention;

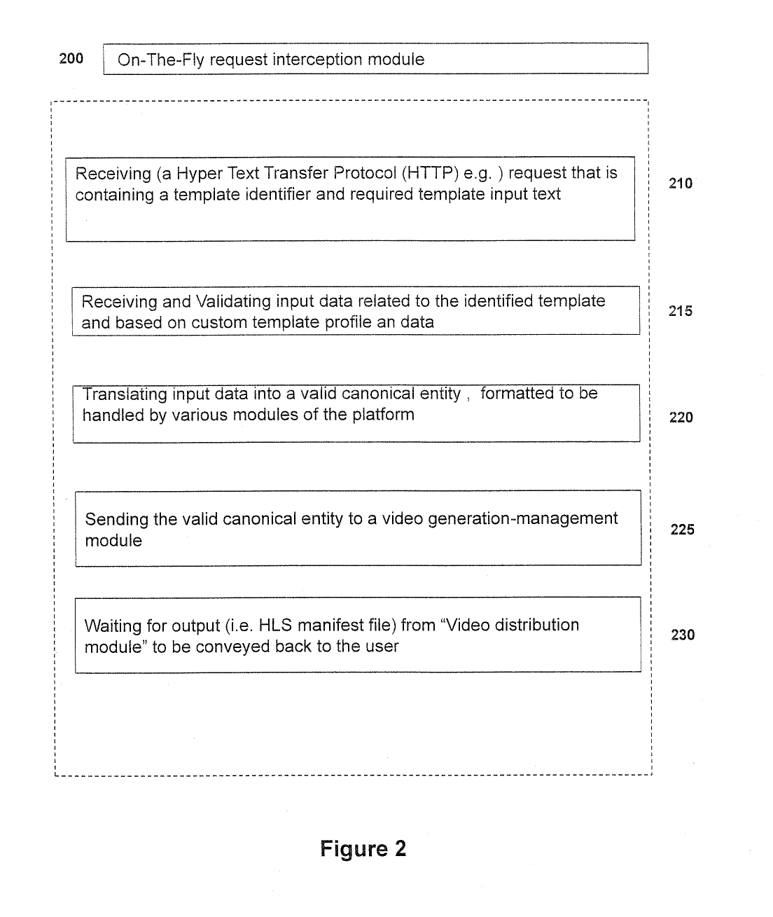

FIG. 2 is a flowchart diagram of On-The-Fly request interception module, according to some embodiments of the invention;

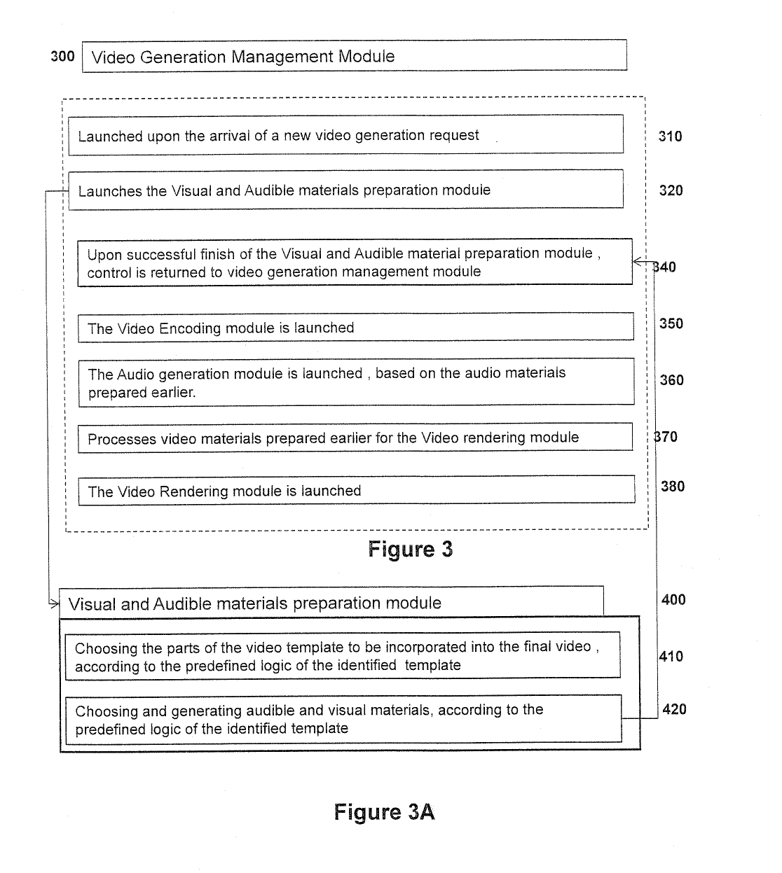

FIG. 3 is a flowchart diagram of video generating management module, according to some embodiments of the invention;

FIG. 3A is a flowchart diagram of Visual and Audible materials preparation module, according to some embodiments of the invention;

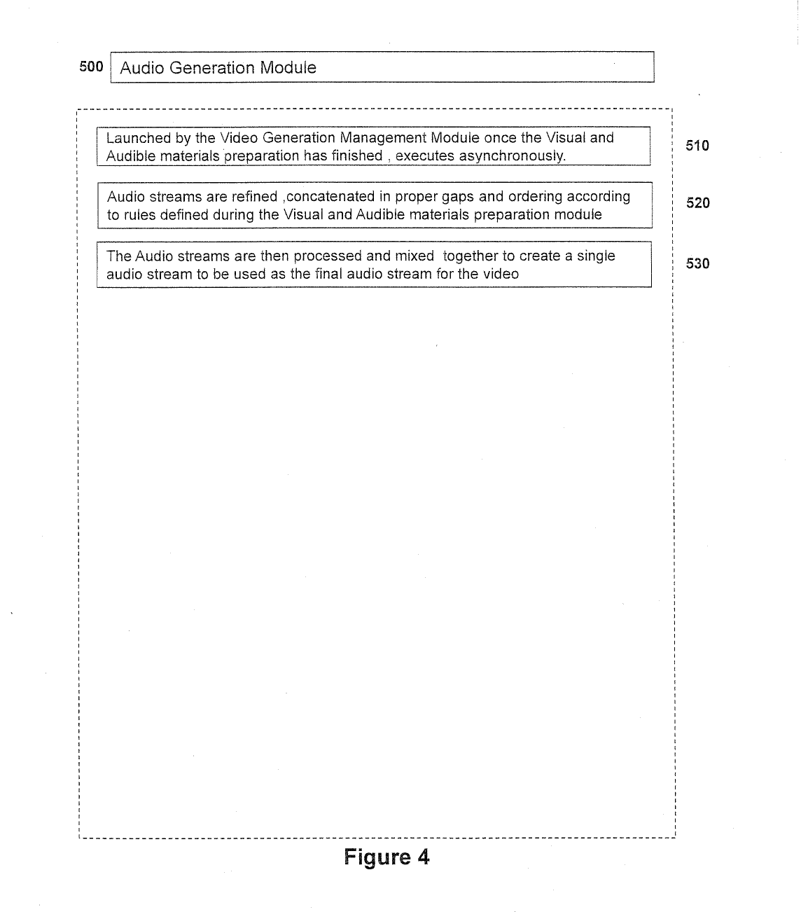

FIG. 4 is a flowchart diagram of Audio Generation Module, according to some embodiments of the invention;

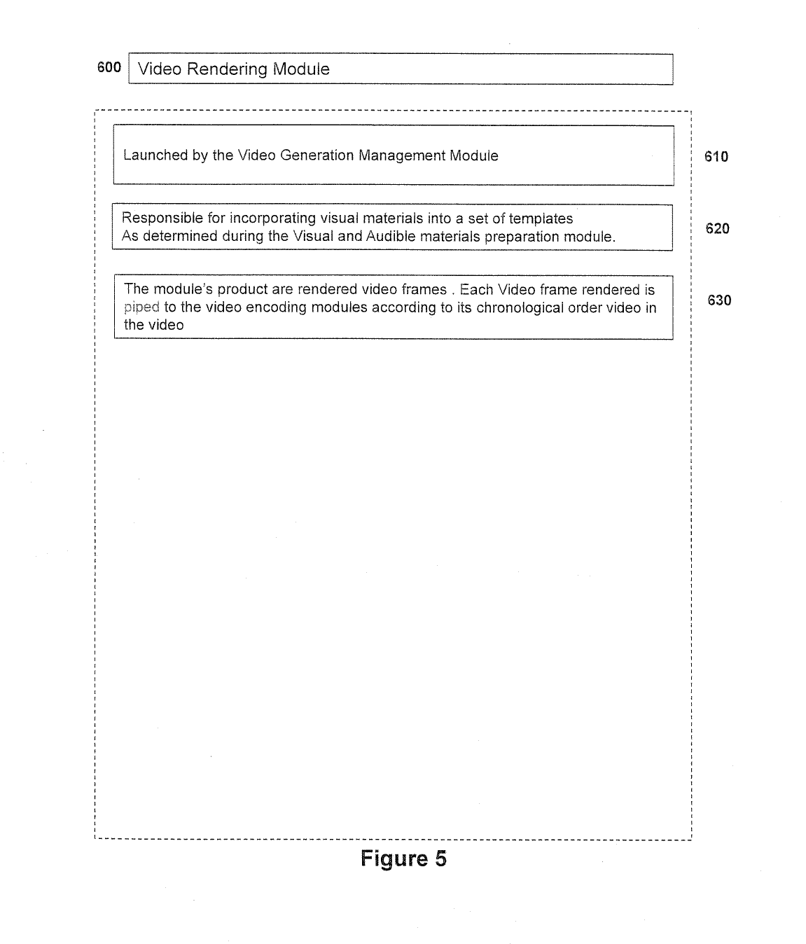

FIG. 5 is a flowchart diagram of Video GPU Rendering module, according to some embodiments of the invention;

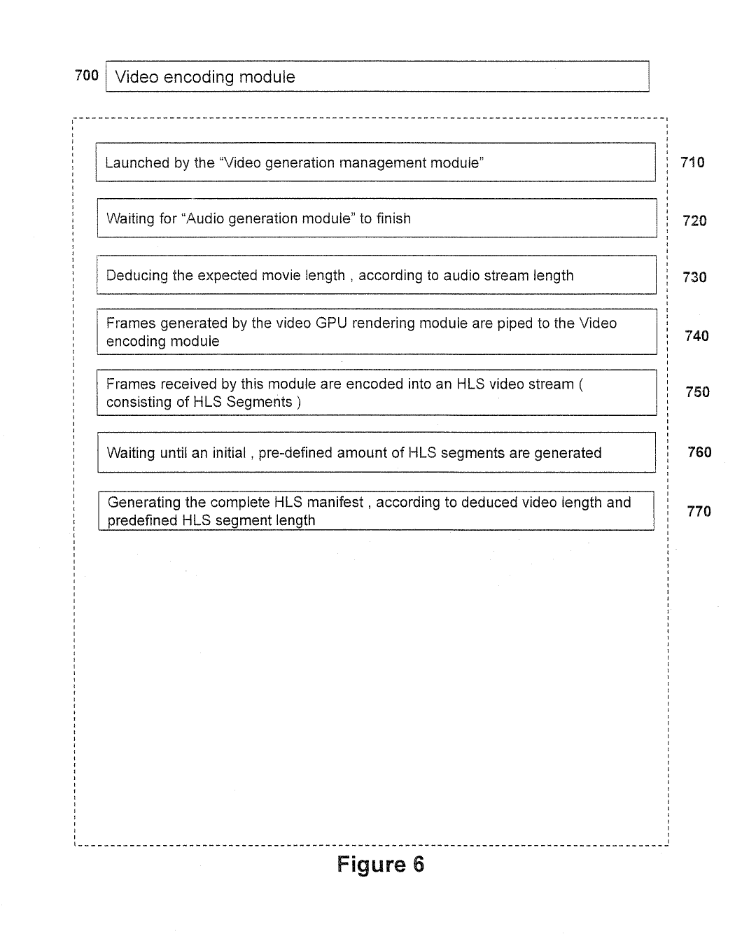

FIG. 6 is a flowchart diagram of video encoding module, according to some embodiments of the invention;

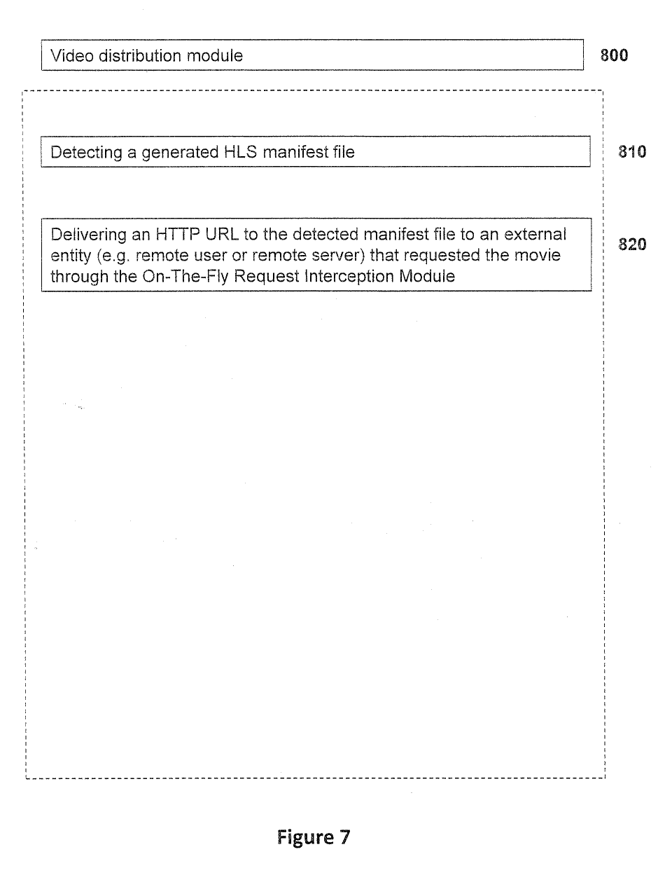

FIG. 7 is a flowchart diagram of request video distribution module, according to some embodiments of the invention;

### DETAILED DESCRIPTION OF THE VARIOUS MODUELS SCHEMATICS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 1 is a block diagram of video generation and streaming platform and processing, according to some embodiments of the invention. The video generation and streaming platform comprises real time request interception module 200 for managing and/or coordinating user or system requests for generating context based video such as customized or personal video, according to pre-defined template. Each validated request video request triggers launch of the Video generation management module 300. The Video generation management 300 launches the Visual and Audible material preparation module 400 which generates and determines the required visual and audible material for creating the video. Once the preparation process is done, the Video generation management 300 launches Audio generation module 500, Video rendering GPU module 600 and the video encoding module 700.

The Audio generation module 500 creates the final audio stream for the video. Once the final audio stream is ready, the Video Encoding module 700 starts the video encoding sequence using the final audio stream and the video frames received from the Video GPU Rendering Module 600. The Video Encoding Module 700 starts generating an HLS video stream consisting HLS Segments.

Once a predefined amount of HLS Segments are generated which represents at least a portion of the generated video, the Video Encoding Module 600 generates the HLS manifest file consisting of entries pointing to the generated HLS segments. The Video Distribution Module 600 identifies the creation of the HLS manifest file, and distributes it back to the requesting entity through the On the Fly Interception module 200.

The above video generation flow enables an external entity to stream the portion of the video already created while the reminder of the video is still being encoded. Accordingly the client can start watching the video while the video generation is still in process.

FIG. 2 is a flowchart diagram of On-The-Fly request interception module, according to some embodiments of the invention. A remote entity dispatches a video generation request for a context based video (such as a personal video) , containing a template identifier and required context input data for generation a video based on the template (210). Upon retrieving the context input data such as user profile, the context input data is validated based on custom template profile (step 215). The context input data is then translated into a canonical entity, which is handled by various modules of the video generation process (step 220). The canonical entity is then transferred to the video preparation video module (225). Once the output of the manifest video file is received from the video distribution module, the video file is conveyed back to the remote entity (step 230).

FIG. 3 is a flowchart diagram of video generating management module, according to some embodiments of the invention. The module is launched upon the arrival of a new video generation request (step 310). At the first stage, the module Launches the Visual and Audible materials preparation module step 320). Then the Visual and Audible module (see FIG. 3A) chooses the parts of the video template to be incorporated into the final video, according to the predefined logic of the identified template (step 410) and accordingly chooses and/or generates the audible and visual materials, according to the chosen template parts (step 420).

Upon successful finish of the Visual and Audible material preparation module the control is returned to video generation management module, for performing the following task: launching the Video Encoding module (step 350), launching the Audio generation module, based on the prepared audio materials (step 360), Processes video materials prepared earlier for the Video rendering module (step 370) and launching the Video Rendering module (step 380).

FIG. 4 is a flowchart diagram of Audio Generation module, according to some embodiments of the invention. This module is launched by the Video Generation Management Module, once the Visual and Audible materials preparation has finished and executes asynchronously (step 510). The Audio Generation module processes the audible materials preparation by refining the Audio streams and concatenating in proper gaps and order according to rules defined during the Visual and Audible materials preparation module (step 520). Next, the Audio streams are further processed and mixed together to create a single audio stream to be used as the final audio stream for the video (step 530)

FIG. 5 is a flowchart diagram of video rendering module, according to some embodiments of the invention. The module is launched by the Video Generation Management Module (step 610). This module is responsible of incorporating the visual material prepared earlier into a set of pre-determined templates (Step 620), as determined during the Visual and Audible materials preparation module. Following right after, the module's products are rendered into video frames, which are piped into the Video Encoding module 700 in the chronological order of their placement in the video stream (Step 630)

FIG. 6 is a flowchart diagram of video encoding module, according to some embodiments of the invention. This module is launched by the Video Generation Management Module (step 710). The module's processing is suspended until the final audio stream is ready (step 720). Based on the final audio stream length ,the complete movie duration is determined (step 730). This module then starts receiving generated video frames from the Video rendering module, encoding them along-side the audio stream into an HLS Video stream, consisting of fixed size MPEG-TS segments (steps 730-750). Once a predefined portion of the HLS video stream is generated (implying a predefined number of HLS Segments) the generation of an HLS manifest file (pointing to the full list of HLS segments that represents the complete video stream ,according to deduced video length and predefined HLS segment length) is trigged (step 760-770).

FIG. 7 is a flowchart diagram of request video distribution module, according to some embodiments of the invention. Once the generation of the HLS manifest file is detected, this module generates a corresponding link and conveys it to the external entity (e.g. remote user or remote server) that requested the personal video through the On-The-Fly Request Interception Module (steps 810, 820)

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

1. A method for real-time generation and streaming of context based video according to video template and raw context related data, said method comprising the steps of:
receiving context based video request that is containing a template identifier and required template input;
receiving input data related to the identified template and context related data;
choosing and generating audible and visual materials, according to the predefined logic of the identified template;
generating and encoding video frames for pre-defined portion based generated visual materials;
generating audio streams of the video based on generated audible materials;
accumulating a predefined number of generated frames to fill a predefined duration of predefined portion according to per-decided frame-rate per second; and
providing streamable data of the predefined video portion at the external entity side, while the subsequent portion of video is still in generation.

2. The method of claim 1 wherein the context based video is customized video based on context input data.

3. The method of claim 1 the received input data is validated and translated into a valid canonical entity for generating material for the context based video.

4. The method of claim 1 wherein the audio stream generation includes: refining and concatenating audio streams in proper gaps and order according to rules defined during the Visual and Audible materials preparation

5. The method of claim 4 wherein the audio stream generation further includes: processing and mixing together audio streams to create a single audio stream to be used as the final audio stream for the video.

6. The method of claim 4 wherein based audio stream length, the expected movie length is deduced.

7. The method of claim 1 wherein the providing playable video data comprise the steps of creating at least two HLS segments and generating an HLS manifest file.

8. A system for real-time generation and streaming of context based video according to video template and context input data , said system comprised of:
interception module for receiving context based video request that is containing a template identifier and required template input, receiving input data related to the identified template and to specific context based on context input data;
visual and audio material preparation module choosing and generating audible and visual materials, according to the predefined logic of the identified template;
video generating management module for generating and encoding video frames for pre-defined portion based generated visual materials;
audio generation module for generating audio streams of the video based on generated audible materials,
video encoding module for accumulating a predefined number of generated frames to fill a predefined duration of predefined portion according to per-decided frame-rate per second; and
video distribution module for providing streamable/playable data of the predefined video portion at the client side, while the subsequent portion of video is still in generation process;.

9. The system of claim 9 wherein the context based video is customized video based on context input data.

10. The system of claim 9 wherein the received input data is translated into a valid canonical entity for generating material for the context based video.

11. The system of claim 9 wherein the audio stream generation module further enable refining and concatenating audio in proper gaps and ordering according to rules defined during the Visual and Audible materials preparation module

12. The system of claim 12 wherein the audio stream generation module further enable and processing and mixing together audio streams to create a single audio stream to be used as the final audio stream for the video.

13. A method for real-time generation and streaming of customized/personalized video based on video template and raw personal data , said method comprising the steps of:
estimating video characteristics base on video template and raw data before the video generation, said estimating includes at least the video length; and
preparing at least a portion of the video , according to pre-defined length of at least the minimum required amount to convey a live stream to the remote entity while the subsequent portions of the video are being generated.
